(19) United States
(12) Patent Application Publication
(10) Pub. No.: US 2009/0188157 A1
(43) Pub. Date: Jul. 30, 2009

(54) DEVICE AND METHOD FOR COMBINING OILS WITH OTHER FLUIDS AND MIXTURES GENERATED THEREFROM

(76) Inventors: William D. Holloway, JR., Carlsbad, CA (US); Michael A. Holloway, Escondido, CA (US); Kenneth H. Tarbet, Snowflake, AZ (US)

Correspondence Address: LAW OFFICE OF DONALD L. WENSKAY, 16909 VIA DE SANTA FE, 200, P.O. BOX 7206, RANCHO SANTA FE, CA, 92057, US

(21) Appl. No.: 11/831,877

(22) Filed: Jul. 31, 2007

Related U.S. Application Data
(63) Continuation-in-part of application No. 11/448,602, filed on Jun. 6, 2006, now abandoned.
Application No. 11/448,602 is a continuation-in-part of application No. 11/302,967, filed on Dec. 13, 2005.
Application No. 11/302,967 is a continuation-in-part of application No. 10/420,280, filed on Apr. 21, 2003.
Application No. 10/420,280 is a continuation-in-part of application No. 10/301,416, filed on Nov. 21, 2002, now abandoned.
Application No. 10/301,416 is a continuation-in-part of application No. 09/698,537, filed on Oct. 26, 2000, now Pat. No. 6,521,248.
(60) Provisional application No. 60/820,950, filed on Jul. 31, 2006.
(60) Provisional application No. 60/595,095, filed on Jun. 6, 2005.
(60) Provisional application No. 60/596,170, filed on Sep. 6, 2005.
(60) Provisional application No. 60/780,947, filed on Mar. 8, 2006.
(60) Provisional application No. 60/801,231, filed on May 16, 2006.
(60) Provisional application No. 60/635,915, filed on Dec. 13, 2004.
(60) Provisional application No. 60/596,170, filed on Sep. 6, 2005.
(60) Provisional application No. 60/594,612, filed on Apr. 22, 2005.
(60) Provisional application No. 60/594,540, filed on Apr. 15, 2005.
(60) Provisional application No. 60/161,546, filed on Oct. 26, 1999.

(51) Int. Cl. C10L 1/18; B01J 19/00

(52) U.S. Cl. 44/301; 44/308; 422/127

(57) ABSTRACT

A device and method a provided for mixing and enhancing reaction between oil and a non-oil liquid by exploiting the formation, implosion and explosion of numerous cavitation bubbles within a cavitation device. Intense localized energy from the collapse of the cavitation bubbles subjects the mixture to intense heat and pressure, thereby accelerating reaction between the oil and non-oil liquid. In one embodiment, the non-oil liquid is an alcohol, and the cavitation device is used to enhance a transesterification reaction to convert the oil and alcohol into biodiesel in the presence of a catalyst.

### RELATED APPLICATIONS

This application claims the priority of provisional application No. 60/820,950, filed Jul. 31, 2006, and is a continuation-in-part of application Ser. No. 11/448,602, filed Jun. 6, 2006, which claims priority to each of provisional applications No. 60/595,095, filed Jun. 6, 2005, No. 60/596,170, filed Sep. 6, 2005, No. 60/780,947, filed Mar. 8, 2006, and No. 60/801,231, filed May 16, 2006, and which is a continuation-in-part of application Ser. No. 11/302,967, filed Dec. 13, 2005, which claims the priority to provisional applications No. 60/635,915, filed Dec. 13, 2004, No. 60/596,170, filed Sep. 6, 2005, No. 60/594,612, filed Apr. 22, 2005 and No. 60/594,540, filed Apr. 15, 2005, and which is a continuation-in-part of Ser. No. 10/420,280, filed Apr. 21, 2003; which is a continuation-in-part of application Ser. No. 10/301,416, filed Nov. 21, 2002, which is a continuation-in-part of application Ser. No. 09/698,537, filed Oct. 26, 2000, now issued as U.S. Pat. No. 6,521,248, which claims priority to provisional application No. 60/161,546, filed Oct. 26, 1999. Each of the above-identified applications is incorporated by reference in its entirety and for all purposes.

### FIELD OF THE INVENTION

The invention relates generally to controllably forming and using the cavitation bubbles formed in a device as chemical reaction chambers. Moreover, the invention exploits the energy released during collapse of the cavitation bubble for promoting and causing chemical reactions, including formation of fuel from oils.

### BACKGROUND OF THE INVENTION

All liquids are made of molecules that interact in a system of attraction in equilibrium with repulsions. These forces play an important role in the formation of large molecular matrices or arrays or pseudo-polymeric systems. Such large arrays or pseudo-polymeric structures are responsible for many of the liquids observed properties, such as boiling point, surface tension and viscosity, for example. The disruption of these large molecular associations or pseudo-polymeric interactions results in modulation of the liquids properties.

Common knowledge has it that oil and water do not mix. Oil-like liquids, called “lipophilic”, have historically been categorized as hydrophobic, having no miscibility in water. Substantial research has been dedicated to the search for methods and techniques whereby a stable emulsion can be made of hydrophobes and hydrophiles, e.g., pulling oils and lipophilics into solution in water. Water is a polar molecule, and hydrophiles are water loving due to one or more polar interactions. These polar interactions often involve a hydrogen atom, which is bound to a polarizable atom, such as oxygen, an interaction that is often referred to as hydrogen bonding. Hydrogen bonding is one key interaction that impacts the solubility of a substance in water. Most hydrophiles, such as sugar, table salt and even drinking alcohol are able to form hydrogen bonds with water, and thus are soluble.

Hydrophobes, such as oils are a large class of compounds and compositions that are not able to form hydrogen bonds with water. Moreover, many oils are non-polar, meaning the molecule does not have charged regions. In general, hydrophobes are not water-soluble secondary to the inability to form hydrogen bonds, which is related to the absence of charged regions.

Oils are also frequently combined with other materials to induce reactions to generate a product. One particular product of interest is biodiesel—an environmentally safe, renewable, biodegradable and non-toxic fuel. Biodiesel is made by chemically reacting vegetable oil or animal fat, or combinations thereof, with an alcohol and a catalyst. The conventional process for making biodiesel involves batch reactors using heat and mechanical energy. The base catalyst, usually sodium hydroxide (NaOH), induces transesterification of fatty acids with the alcohol, which is usually methanol. Typically, the oil must be heated before mixing with the methanol and the catalyst. When combined in the correct proportions and mixed for periods ranging from 1 to 5 hours over heat (˜140° F.), the result is a fatty acid methyl ester (FAME) and the by-product glycerol. The FAME is less dense than the glycerol, so, after allowing the mixture to settle for several hours, the FAME floats to the top, allowing separation by decanters or centrifuges. After separation of the FAME, the liquid may be washed to remove contaminants, including unfiltered particulates, methanol and glycerol. The process for making biodiesel, thus, can be time and energy consuming. With the increasing demand for alternative and renewable fuels, there is a need for a process for producing biodiesel that is faster and consumes less energy than conventional processes.

It is generally known that cavitation bubbles generated in non-volatile liquids, which specifically excludes water, are capable of sufficient energy to cause chemical reactions and, in some situations, produce light. It is possible to hold a single bubble of gas in a standing acoustic wave and drive it into pulsations, causing the bubble to convert sonic energy into light with clocklike regularity. At the same time, the intense energy released by the implosive compression of the bubble rips molecules apart. This energy is converted into light emission, chemical reactions and mechanical energy. This process, known as “sonochemistry”, has been studied for industrial and medical applications. The largest part of the sonic energy is converted into mechanical energy, causing shock waves and motion in the surrounding liquid. Sonochemistry arises from acoustic cavitation—the formation, growth and implosive collapse of small gas bubbles in a liquid blasted with sound. The collapse of these cavitating bubbles generates intense local heating, forming a hot spot in the cold liquid with a transient temperature of about 9,000° F., the pressure of about 1,000 atmospheres and the duration of about 1 billionth of a second. Sonochemistry has already found diverse applications, including making catalysts to remove sulfur from fuels and enhancing the chemical reactions used in making pharmaceuticals.

### SUMMARY OF THE INVENTION

It is an object of the present invention to apply sonochemistry-based techniques to processing of oil mixtures to provide improved mixing with greater efficiency.

The present invention relates to a device and method for processing liquids, including water, which induce and exploit the formation, implosion and explosion of numerous cavitation bubbles. Substantial chemistry is caused within some of these cavitation bubbles, causing them, in a sense, to become minute reaction chambers. These reaction chambers are formed, filled with reactants and collapse within a short time frame, perhaps micro- to picoseconds, or even femtoseconds. During the implosion of these bubbles, intense pressures and temperatures are reached, thereby accelerating the chemical reaction. Although the temperatures and pressures are extreme, they are transient and short in duration as they are rapidly dispersed by the water (or other liquid) in which they occur. The cavitation reaction chambers form because of the fluid-flow mechanics within the device. The cavitation reaction chambers are self-filling with chemical reactants, pulling from the surrounding fluid as needed. Upon collapse, the cavitation chambers are self-cleaning, through auto-destruction. The temperatures and pressures required to facilitate the desired chemical reaction are reached through the implosion process so that temperature and pressure of the reaction does not need to be regulated by temperature- or pressure-controlling devices.

In one aspect of the invention, a method is provided for producing a mixture of an oil and a non-oil liquid comprising: iteratively cycling the oil and the non-oil liquid together within a loop comprising a cavitation device to produce cavitation bubbles within the oil and the non-oil liquid, wherein collapse of the cavitation bubbles produces shock waves that produce localized heat and pressure to mix the oil and non-oil liquid; and terminating the cycling once a desired reaction has occurred.

In another aspect of the invention, a device is provided for producing a mixture of an oil and a non-oil liquid, the device comprising a processing loop; means for introducing the oil and non-oil liquid into the processing loop; a pump for pumping a combination the oil and non-oil liquid iteratively through the processing loop until a predetermined condition is achieved; a cavitation device disposed within the loop, the cavitation device comprising a plurality of nozzles disposed within a chamber, wherein the plurality of nozzles produce cavitation bubbles within the oil and non-oil liquid, wherein collapse of the cavitation bubbles produces shock waves that produce localized heat and pressure to induce reaction between the oil and non-oil liquid; and an outlet port for removing a reacted mixture once the predetermined condition has been achieved.

In one embodiment, the inventive method utilizes cavitation in the conversion of vegetable oils or animal fats to biodiesel. Using the inventive device and method to facilitate the transesterification reaction reduces biodiesel processing time from the conventional 1 to 5 hours to less than 5 minutes. Cavitation also enables the use of a reduced amount of catalyst by 30 to 40% due to the increased chemical activity in the presence of cavitation.

### BRIEF DESCRIPTION OF THE DRAWINGS

FIG. 1 shows a water molecule and the resulting net dipole moment.

FIG. 2 shows a large array of water molecules.

FIG. 3 shows a micro-cluster of water having five water molecules forming a tetrahedral shape.

FIG. 4 is a diagrammatic top view of a device for creating cavitation.

FIG. 5A shows FTIR spectra for reverse osmosis water.

FIG. 5B shows FTIR spectra for micro-cluster water according to the present invention.

FIG. 6 shows TGA plots for two types of water.

FIGS. 7A, 7B and 7C show NMR spectra for three types of water, where FIG. 7A shows the spectra for distilled water, FIG. 7B shows the spectra for micro-cluster water with no added oxygen, and FIG. 7C shows the spectra for micro-cluster water with oxygen added.

FIG. 8 is a flow diagram of the main steps in a process for making micro-cluster water.

FIG. 9 is a flow diagram of a preferred pre-processing technique for cleaning typical city water to prepare the water for creation of micro-clusters.

FIG. 10A is a cross-sectional view of one embodiment of a cluster fractioning unit taken along line 10A-10A of FIG. 10B.

FIG. 10B is a cross-sectional view of the cluster fractioning unit taken along line 10B-10B of FIG. 10A.

FIGS. 11A-D show views of an embodiment of a cluster fractioning module, where: FIG. 11A is a top view of the module; FIG. 11B is a side view of the bottom part of the module; and FIGS. 11C and 11D are inside surface and side views, respectively, of the module lid.

FIGS. 12A-12H show views of the fractioning nozzle and its parts, where: FIG. 12A is a side view of an assembled nozzle; FIG. 12B is a side view of the bottom part of the nozzle; FIG. 12C is a cross-sectional view of the bottom part taken along line 12C-12C of FIG. 12B; FIG. 12D is a cross-sectional view of the bottom part of the nozzle taken along line 12D-12D of FIG. 12C; FIG. 12E is a side view of the top part of the nozzle; FIG. 12F is a cross-sectional view taken along line 12F-12F of FIG. 12E; FIG. 12G is a cross-sectional view taken along line 12G-12G of FIG. 12F; and FIG. 12H is a size view of the assembled nozzle showing the interior features in dashed lines.

FIGS. 13A and B show an alternate embodiment of a cluster fractioning module using piezoelectric drivers to create cavitation, where FIG. 13A is a top view of the module with one mounting plate removed; and FIG. 13B is a side view of the module.

FIG. 14 shows a system for testing properties of micro-cluster water against other water.

FIGS. 15A-15C show an alternate nozzle embodiment having five nozzles in a two piece assembly, where FIG. 15A shows the bottom section of the nozzle assembly; FIG. 15B shows the top section of the nozzle assembly; and FIG. 15C is a side view of the top and bottom sections assembled.

FIG. 16 shows an alternate nozzle assembly having five nozzles distributed radially.

FIG. 17 is a front elevation of a preferred embodiment of the cavitation device showing the placement of the nozzles within the housing.

FIG. 18 is a diagrammatic view of a system for mixing incorporating the cavitation device.

FIG. 19 is an exploded side elevation of a nozzle for use in the inventive device.

FIG. 20 is an entrance face view of the front section of the nozzle of FIG. 19.

FIG. 21 is an interior face view of the back section of the nozzle of FIG. 19.

FIG. 22 is an entrance face view of the vacuum plate of the nozzle of FIG. 19.

FIG. 23 is a diagrammatic view of the exit orifice of the nozzle showing the spray pattern of the exiting liquid.

FIG. 24 is a diagrammatic top view of an alternate embodiment of the device with two sets of nozzles.

FIG. 25 is a diagrammatic view of an exemplary biodiesel processor.

### DESCRIPTION OF THE PREFERRED EMBODIMENTS

The cavitation bubble will draw reactants from the surrounding liquid either into the heart of the bubble or along the periphery. Temperature and pressure will increase within the cavitation bubble as the bubble is compressed according to pressures placed on the exterior of the bubble. This rise in temperature and pressure will also affect the outer periphery of the bubble, e.g., the bubble-liquid interface. Some reactants may change to the gas state under these conditions and enter the interior of the bubble. Regardless of state of matter (whether gas, liquid, solid, supercritical or plasma), chemical reactions are facilitated under these conditions.

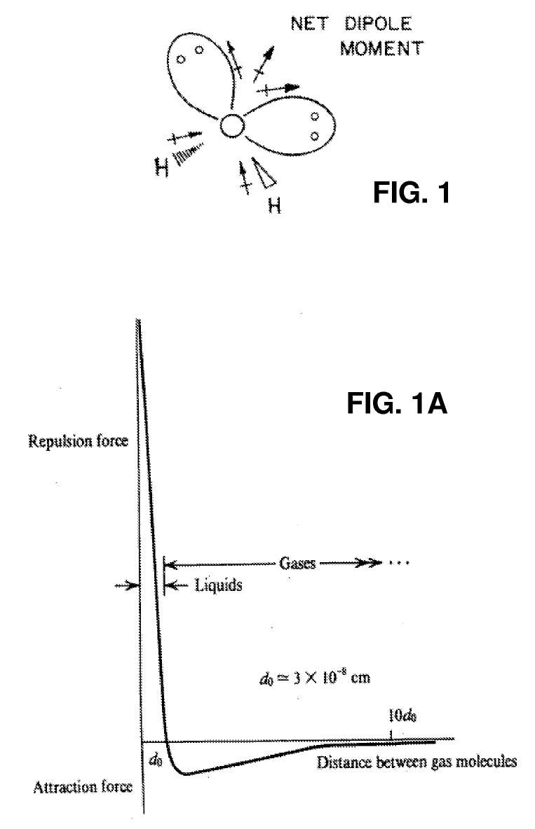

FIG. 1A is a graph showing these repulsive and attractive forces as a function of distance between the molecules. For liquids, the average spacing between simple molecules at normal pressures and temperatures is of the order of d₀, the distance at which the net forces, both attractive and repulsive, is zero. For gases, the spacing is on the order of 10 d₀. When the groups are brought closer than their van der Waals radii (d₀ in FIG. 1A), the force between them becomes repulsive because their electron clouds begin to interpenetrate each other.

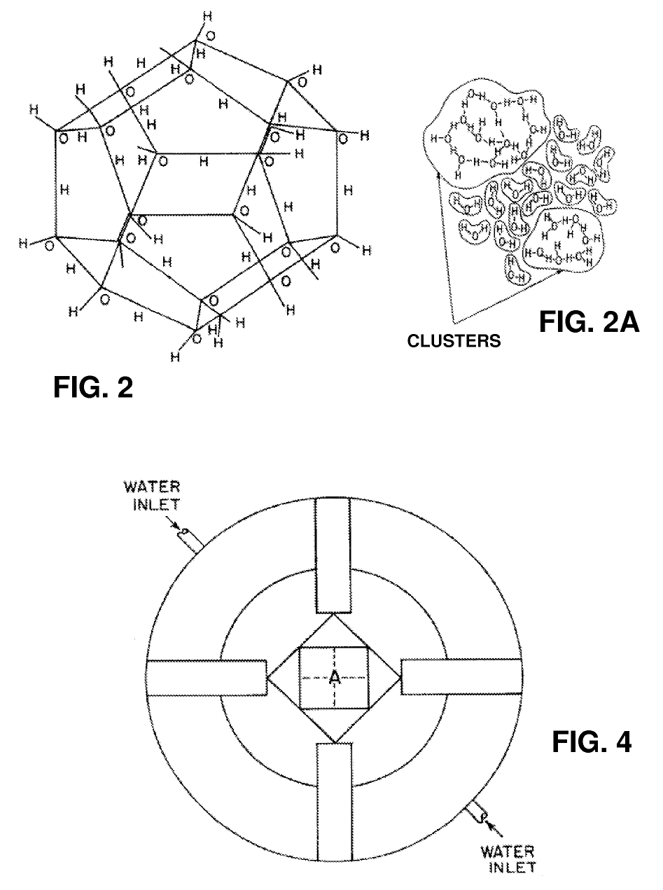

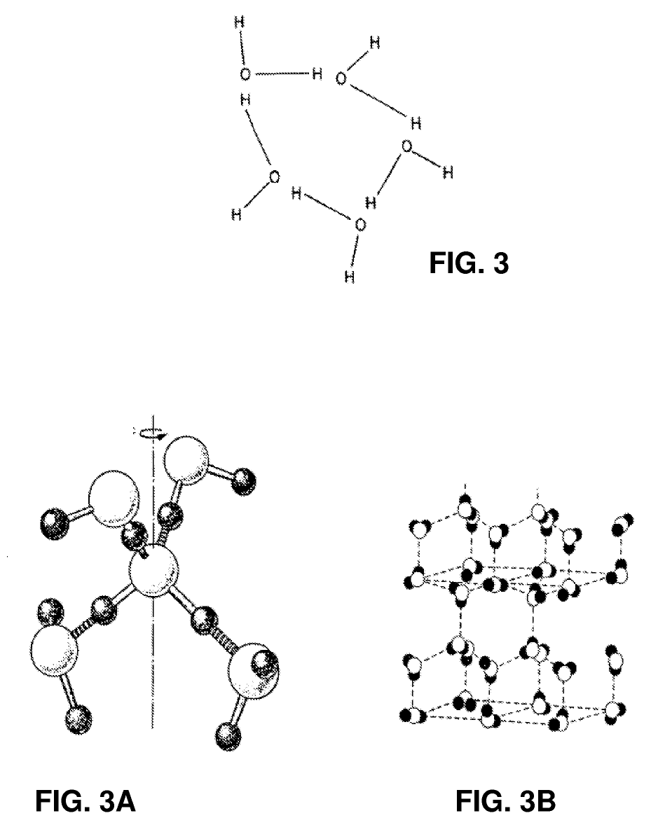

Numerous liquids can be processed using the techniques described herein. Such liquids include water, alcohols, petroleum and fuels. Liquids are molecules comprising one or more basic elements or atoms. In the case of water, the molecules are hydrogen and oxygen. The interaction of the atoms through covalent bonds and molecular charges form molecules. A molecule of water has an angular or bent geometry. The H—O—H bond angle in a molecule of water is 104.5 degrees as depicted in FIG. 1. This configuration creates electrostatic forces that allow for the attraction of other molecules of water. Studies by Pugliano et al., (Science, 257:1937, 1992) have suggested the relationship and complex interactions of water molecules preferably at four locations as indicated in FIG. 1. This can result in a five-molecule water structure as shown in FIGS. 3A and 3B. This five-molecule cluster is a natural molecular configuration of frozen water (ice), but water clusters tend to be much larger, as shown in FIGS. 2 and 2A. An objective of the inventive process and device is to produce water with a substantially increased number of five molecule clusters, hence the name of the water, “Penta® Water”.

Hydrogen bonding and oxygen-oxygen interactions play a major role in creating large clusters of water molecules. Substantially purified water forms complex structures comprising multiple water molecules each interacting with an adjacent water molecule (as depicted in FIG. 2 and FIG. 2A) to form large clusters. These large clusters are formed based upon, for example, non-covalent interactions such as hydrogen bonds and as a result of the dipole moment of the molecule. These large molecules have been suggested to be detrimental in various chemical and biological reactions. Accordingly, in one application of the inventive device, a method of forming fractionized or micro-cluster water molecules having 2 to 5 molecules of H₂O water is provided. The five-molecule cluster is depicted in FIGS. 3 and 3A.

Any number of techniques known to those of skill in the art can be used to create cavitation in a fluid so long as the cavitating source is suitable to generate sufficient acoustic energy to break the large arrays. The acoustic energy produced by the cavitation provides energy to break the large fluid arrays into smaller fluid clusters. For example, acoustical transducers may be utilized to provide the required cavitation source. In addition, a fluid may be forced through a tube having a constriction in its length providing for a high pressure before the constriction, which is rapidly depressurized within the constriction and then pressurized again after the restriction. Another example includes forcing a fluid in reverse direction through a volumetric pump.

In one embodiment, water to be fractionized is pressurized into a rotational volute to create a vortex that reaches partial vacuum pressures creating cavitation bubbles in the vortex. The water then exits at or close to atmospheric pressure to implode the bubbles. This pressurization, sudden decompression and compression again of the water causes the creation and implosion of cavitation bubbles that create acoustical energy shockwaves. The shockwaves break the bonds on large fluid clusters, breaking the weak array bonds to form micro-cluster or fractionized fluid. The resulting fluid consists of, for example, about five H₂O molecules in a quasi tetrahedral arrangement (as depicted in FIGS. 3 and 3A). The micro-cluster water is recycled through the fractionizing process until the desired number of micro-cluster water molecules are formed, as determined by the temperature rise of the fluid over time as cavitation bubbles impart kinetic heat to the processed fluid. Preferably, that temperature is about 140° F. Once the desired conditions are reached, the micro-cluster fluid is cooled. (The desired conditions can be measured in any number of ways but are preferably detected by temperature.) The fluid is cooled slowly. Once the fluid reaches a desired lower temperature, typically at about 4° to 15° C., molecular oxygen is introduced to attain the desired quantity of oxygen in the micro-cluster fluid. The micro-cluster fluid is then preferably dispensed into containers, such as bottles, which are filled to maximum capacity and capped while the oxygenated micro-cluster water is still cool, thus applying a partial pressure to the oxygenated micro-cluster water when the temperature of the water reaches room temperature. This enables larger quantities of dissolved oxygen to be maintained in solution due to increased partial pressure on the bottle's contents.

The present invention provides a method for making a micro-cluster or fractionized liquid. For ease of explanation, water will be used as the example, however any type fluid may be substituted for water. A starting water such as, for example, purified or distilled water, is used as a base material since it is relatively free of mineral content. The water is then placed into a food grade stainless steel tank for processing. The starting water is passed through a pump capable of supplying a continuous pressure of between about 55 and 120 psig or higher to create a continuous stream of water. This stream of water is then introduced into cavitation nozzle configurations capable of establishing a multiple rotational vortex reaching partial vacuum pressures of about minus 12 psig, thereby reaching the vapor pressure of water and of dissolved entrained gases in the water. The cluster fractioning units can have four opposing vortex volutes with a 6-degree acceleration tube exiting into a common chamber at or close to atmospheric pressure, providing less than 5 psig backpressure. The gases and water vapor form cavitation bubbles that travel down multiple acceleration tubes and exit into a common chamber at or close to atmospheric pressure, causing the cavitation bubbles to implode or explode. The resultant shock waves produced by the imploding and exploding cavitation bubbles provides the energy for additional and useful chemistry to happen. Very high temperatures are created at a sub-micron level but the surrounding water rapidly absorbs the heat. In preferred embodiments, the water is repeatedly circulated through the cavitation nozzles until the water temperature has risen from about 77° F. to about 140° F. A similar dissipation of heat occurs where another liquid, say oil, is subjected to the process.

Another embodiment involves the introduction of a gas other than air into the liquid to be processed, such that new, potentially flavorful and useful ions are created and dissolved in the processed water, providing subtle flavorings, without an increase in TDS (total dissolved Solids).

It will be recognized by those skilled in the art that the water produced in accordance with the present invention can be further modified in any number of ways. For example, following formation of the micro-cluster water, the water may be oxygenated as described herein, further purified, flavored, distilled, irradiated, and any number of further modifications known in the art and which will become apparent depending on the final use of the water.

In another embodiment, the present invention provides methods of modulating the rate and extent of a chemical reaction.

As described in the Examples below it is contemplated that the reactants are combined in a suitable fluid, which is processed through the present device, wherein cavitation bubbles are formed and collapsed, whereby the chemical reaction among the reactants is modulated.

The following examples are meant to illustrate applications of the cavitation process to processing of various fluids. Equivalents of the following examples will be recognized by those skilled in the art and are encompassed by the present disclosure.

In a first method for processing a fluid to produce a micro-cluster fluid, about 325 gallons of steam-distilled water from Culligan® Water in 5 gallon bottles at a temperature about 29° C. ambient temperature were placed in a 316 stainless steel non-pressurized tank with a removable top for treatment. The tank was connected by a bottom feed 2¼″ 316 stainless steel pipe that is reduced to 1″ NPT into a 20″ U.S. filter housing containing a 5 micron fiber filter. The filter serves to remove contaminants that may be in the water. Output of the 20″ filter is connected to a Teel model 1V458 316 stainless steel Gear pump driven by a 3 HP 1740 RPM three-phase electric motor by direct drive. At the output of the gear pump, 1″ NPT was directed to a cavitation device via 1″ 316 stainless steel pipe fitted with a 1″ stainless steel ball valve, used for isolation only, and past a pressure gauge. The output of the pump delivers a continuous pressure of 65 psig to the cavitation device.

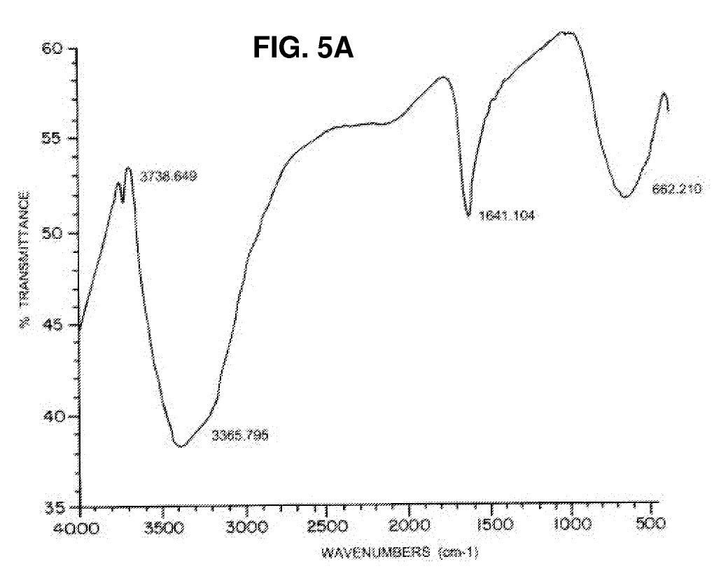

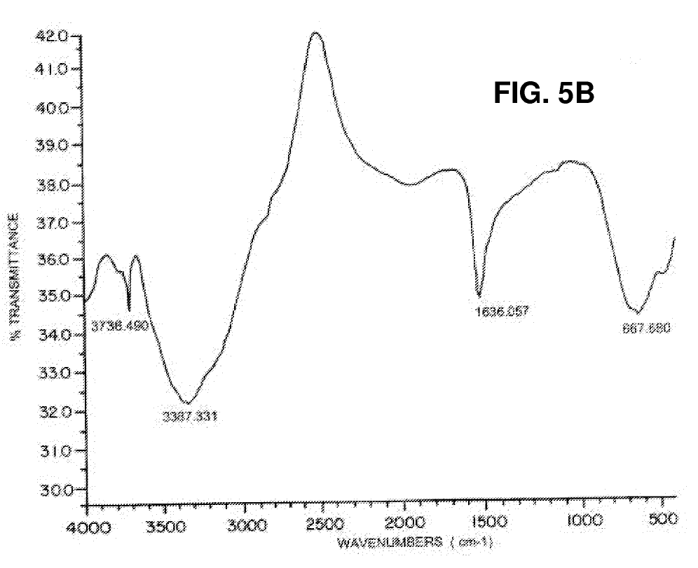

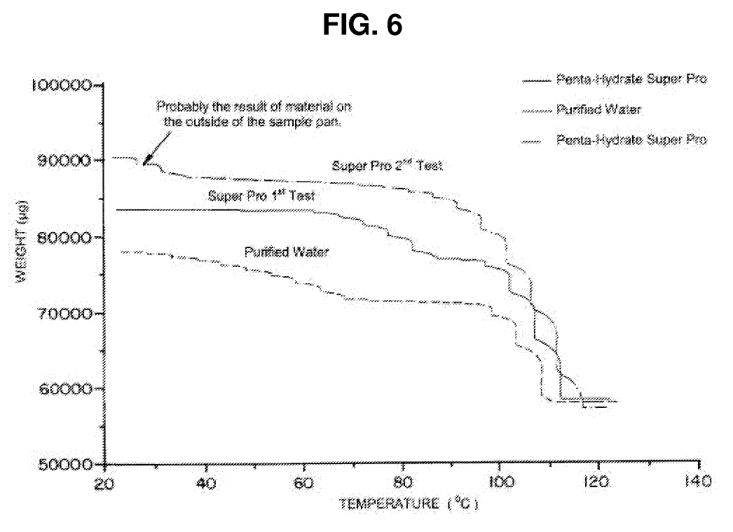

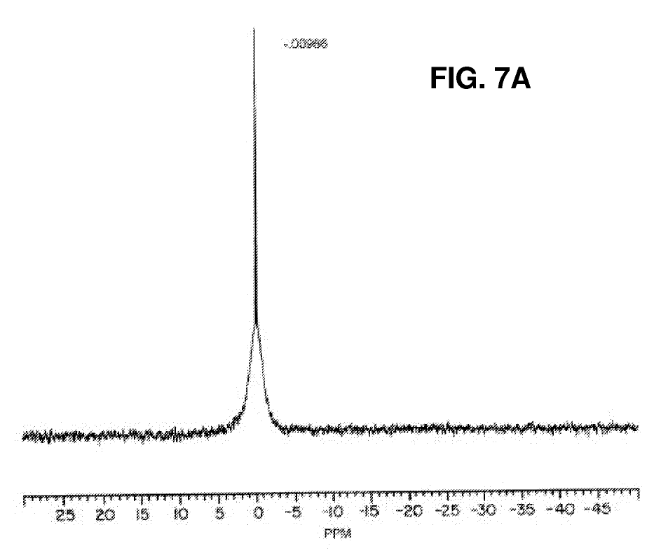

The cavitation device, illustrated in FIG. 4, was composed of four small inverted pump volutes made of Teflon® (polytetrafluoroethylene) without impellers, housed in a 316 stainless steel pipe housing that are tangentially fed by a common water source. The common water source is fed by the 1V458 Gear pump at 65 psig through a ¼″ hole that, although normally used as the discharge of a pump, is utilized as the input for the purpose of establishing a rotational vortex. The water entering the four volutes is directed in a circle 360 degrees and discharged by the means of an 1″ long acceleration tube with a ⅜″ discharge hole. The discharge hole would normally be the suction side of a pump volute but, in this case, is utilized as the discharge side of the device. The four reverse fed volutes establish rotational vortexes that spin the water through one 360 degree rotation, then discharge the water down the four acceleration tubes, each of which provides a 6 degree decreasing angle (as measured from the center line of the tube) acceleration section. The accelerated water is discharged into a common chamber at or close to atmospheric pressure. The common chamber is connected to a 1″ stainless steel discharge line that feeds back into the top of the 325-gallon tank containing the distilled water. At this point, the water has made one treatment pass through the device. The process described above is repeated continuously until the energy created by the implosions and explosions of the cavitation (e.g., due to the acoustical energy) have imparted sufficient kinetic heat to the water to raise the water temperature to about 60 degrees Celsius.

Although they are under no obligation to explain the theory of the invention and are not to be bound by this explanation, the inventors believe that the acoustical energy created by the cavitation breaks the static electric bonds tetrahedral micro-clusters of five H₂O molecules together in larger clusters, thus decreasing the size of the clusters.

A hand held infrared thermal detector through a stainless steel thermo well was used to detect the temperature of the water. Those of skill in the art will recognize that there are other methods of assessing the temperature. Once the temperature of 60 degrees C. has been reached, the pump motor is secured and the water is left to cool. An 8-foot by 8 foot insulated room fitted with a 5,000 Btu air conditioner is used to expedite cooling, but this is optional. During cooling, the processed water should not be agitated, and should be moved as little as possible.

A target cooling temperature of 4° C. can be used, however, 15° C. is sufficient. The target cooling temperature will vary depending upon the quantity of water being cooled. Once sufficiently cooled to about 4° to 15° C., the water can be oxygenated. After cooling, the processed water is transferred from the 325-gallon stainless steel tank into 5-gallon polycarbonate bottles for oxygenation. Oxygenation is accomplished by applying oxygen gas at a pressure of 20 psig input through a ¼″ ID plastic line fitted with a plastic air diffuser utilized to make fine air bubbles (e.g., Lee's Catalog number 12522). The plastic tube is run through a screw-on lid on the 5-gallon bottle until it reaches the bottom of the bottle. The line is fitted with the air diffuser at its discharge end. The oxygen is applied at 20 psig flow pressure to insure a good visual flow of oxygen bubbles. In one embodiment (Oxy-Hydrate), the water is oxygenated for about five minutes. In another embodiment (Oxy-Hydrate Pro), the water is oxygenated for about ten minutes.

Immediately after oxygenation, the water is bottled in 500 ml PET (polyethylene terephthalate) bottles, filled to overflowing and capped with a pressure seal type plastic cap with inserted seal gasket. In one embodiment, the 0.5 liter bottle is over-filled so that when the temperature of the water increases to room temperature it will self pressurize the bottle, retaining a greater concentration of dissolved oxygen at partial pressure. This step not only keeps more oxygen in a dissolved state, but also helps minimize agitation of the water during shipping.

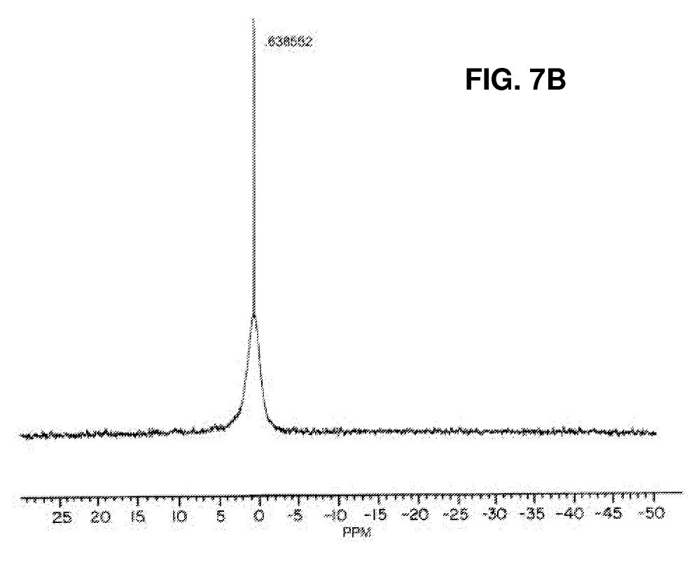

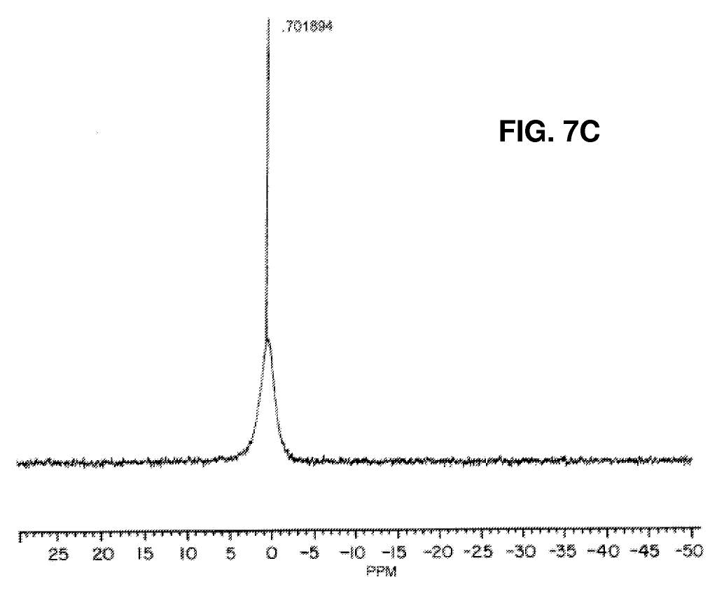

A second preferred process and device for making micro-cluster water are shown in FIGS. 8-12. FIG. 8 is a summary block diagram of the entire process. City water 20 at a flow rate of 40 GPM is processed through a set of initial processing equipment 22 to reduce the total dissolved solids in the water from about 450 ppm to a level of 0.4 ppm. This portion of the process utilizes reverse osmosis equipment, which results in a sewer discharge of about 25 percent of the incoming water, leaving a net flow rate of about 30 GPM. This initial processing continues until a 2000 gallon holding tank 24 is filled. The water in tank 24 is treated with ozone to maintain an ozone level of 0.10 ppm to 0.20 ppm until the water is ready to be processed in the cluster fracturing system 26. System 24 includes process tank 28, pump 30 and cluster fracturing unit 32. After the 2000-gallon batch has been processed through system 26, the water temperature is 140° F. The water is then pumped into one of three holding tanks 34A, 34B or 34C, then is cooled by cooling system 36 to a temperature of 55° F. Oxygen is then added at oxygenator 38. The water is treated with ultraviolet light 40, then is transferred into water bottles at bottling plant 42.

### Cavitation System

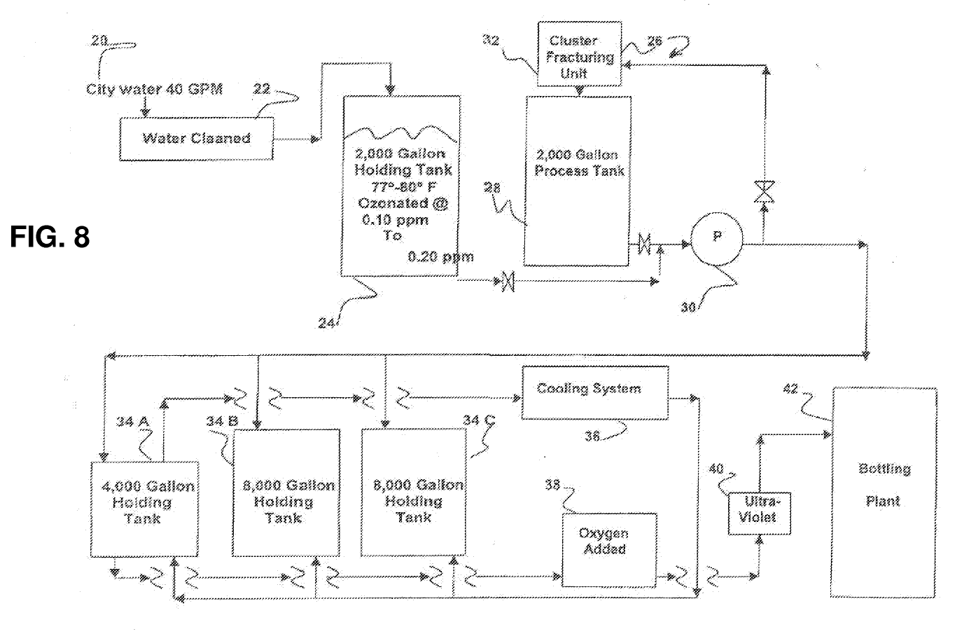

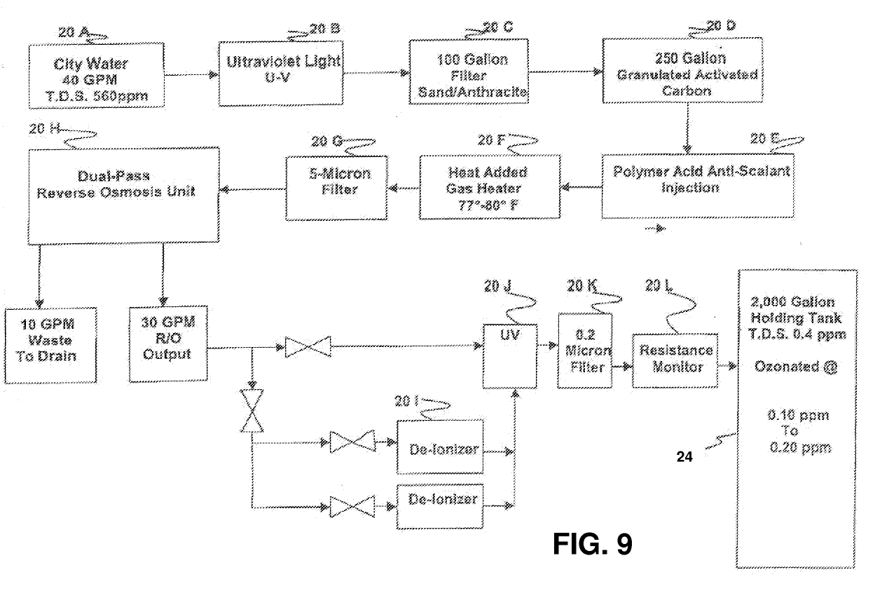

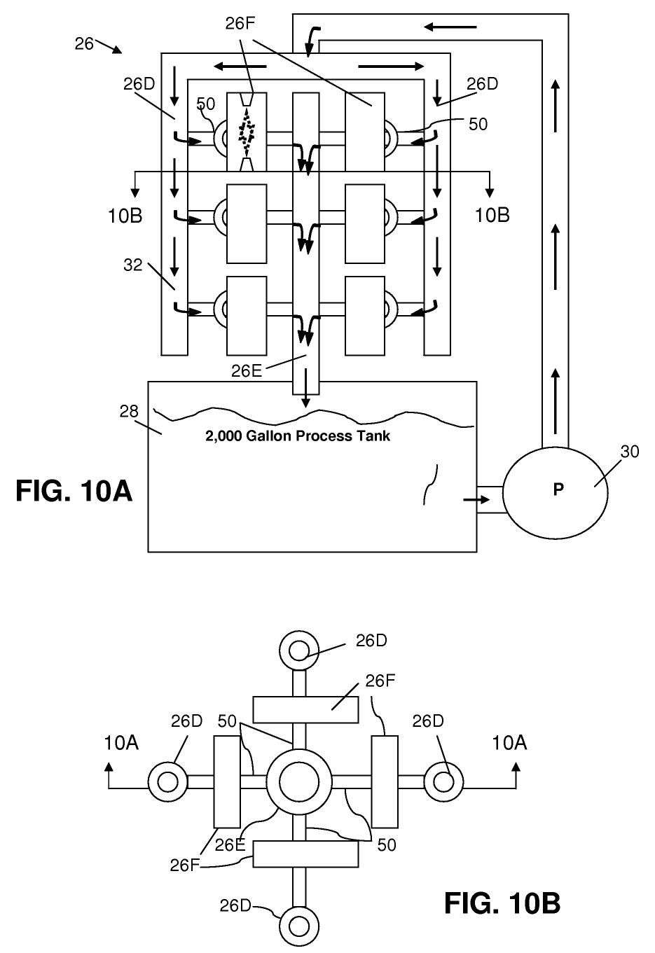

The components of cluster fracturing system 26 are shown in FIGS. 10A through 12F. FIG. 10A shows a side cross-sectional view of the system and FIG. 10B shows a top cross-sectional view of a portion of the system as indicated by the view indicators on the two figures. Referring briefly back to FIG. 8, water is pumped into tank 28 from tank 24 using pump 30 until tank 24 is empty. Pump 30 then re-circulates the water at 400 GPM for about 7 to 8 hours until the water temperature has reached 140° F. Over this period, the water makes about 90 passes through the cluster fractioning unit 32. As illustrated in FIG. 10A, cluster fractioning unit 32 comprises input manifolds 26D, central drain 26E and twelve cluster fracturing modules 26F. Each module comprises a stainless steel base 26G, as shown in FIGS. 11A and 11B, and a stainless steel lid 26H as shown in FIGS. 11C and 11D. The module also includes four nozzles 126 made of Delron® supplied by Dow Chemical. FIGS. 12A-12H illustrate details of the nozzle. The nozzle is formed in two parts that are separable along line 120 in FIGS. 12A and 12H. The top part 128, i.e., the part from which the liquid exits, is shown in FIGS. 12D, E and F. The bottom part 124 is shown in FIGS. 12A, B and C.

Referring again to FIG. 10A, in operation, water is pumped by pump 30 at 400 GPM at a head pressure of 120 psig through input manifolds 26D and y-shaped input tubes 50, which are welded at the holes 52 in the lid 26H of modules 26F, as shown in FIG. 11C and FIG. 11D. The water pressurizes a ¼ inch deep space 58 between the top and base of modules 26F. From space 58, the water is forced through a volute-type cavity 60 in nozzle 126, where it is forced into a helical path 132 accelerating and traveling helically through nozzle 26 and out the nozzle opening 54. Water exits each of the four nozzles 126 in each module 26F in a circulating fan-shaped pattern 62 so that the exiting water collides with water exiting the adjacently located nozzles 126 as shown in FIG. 11A. Rapid decompression along the centerline inside the nozzle creates cavitation bubbles, which immediately collapse when they encounter higher pressures in the nozzle and when exiting the nozzle. The collapse of the bubbles create cavitations (with extremely high temperatures and pressures) producing microscopic explosions with pressure waves having tremendous localized forces sufficient to break up large molecular structures in the water and creating microstructures.

A third process for making micro-cluster water is the same as that described for the second process except for the cluster fractioning technique. In this case, piezoelectric drivers create cavitation bubbles in the water which quickly collapse under the water pressure to generate shock waves similar to the ones created in the vortex unit of the second process. The following piezoelectric ultrasonic equipment is preferred for creating the cavitation effects:

4 Branson Ultrasonics 2000b/bdc power supplies.

4 Branson Ultrasonic CR Converters pn 101-1350060

4Branson Ultrasonic Hi-Gain Horns 2 inch dia, titanium pn 316-017-021

4 Branson Ultrasonic Solid mount Boosters, silver, amplitude radio 1:2 pn 101-149-098

4Branson Ultrasonics J911 15 foot start cable

1 four-way feedthrough cross 316L stainless steel ultrasonic cavitation chamber specially manufactured.

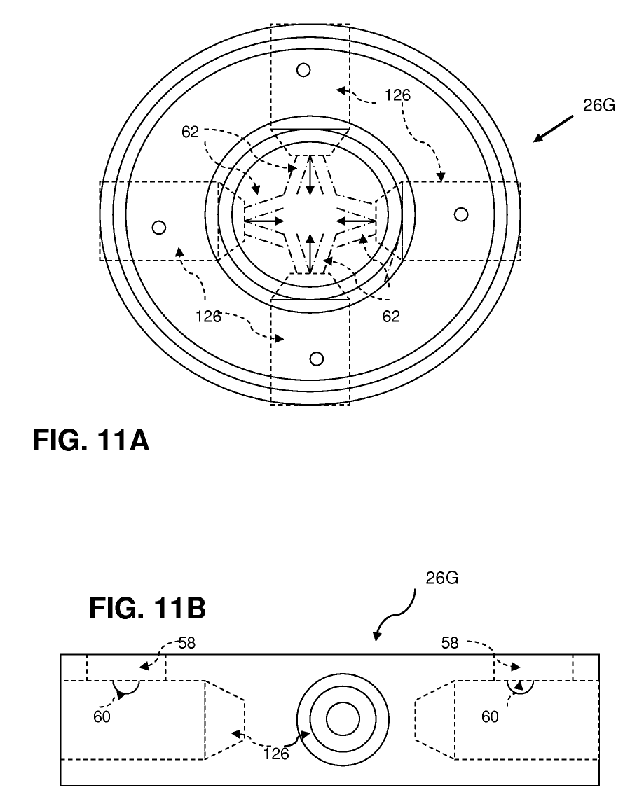

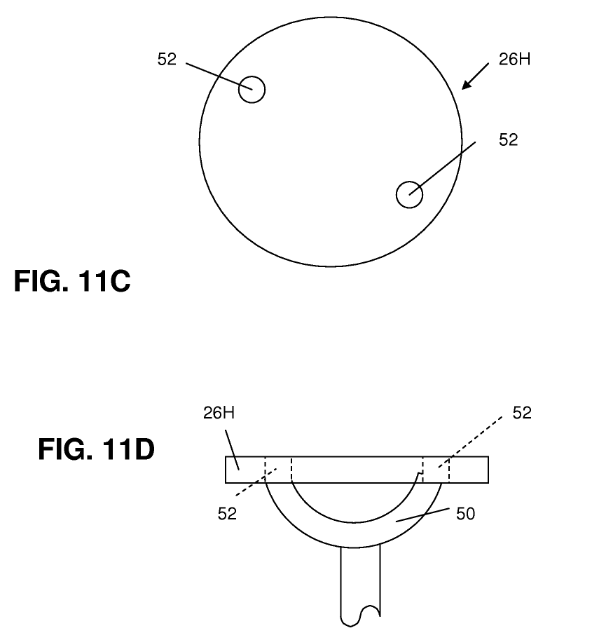

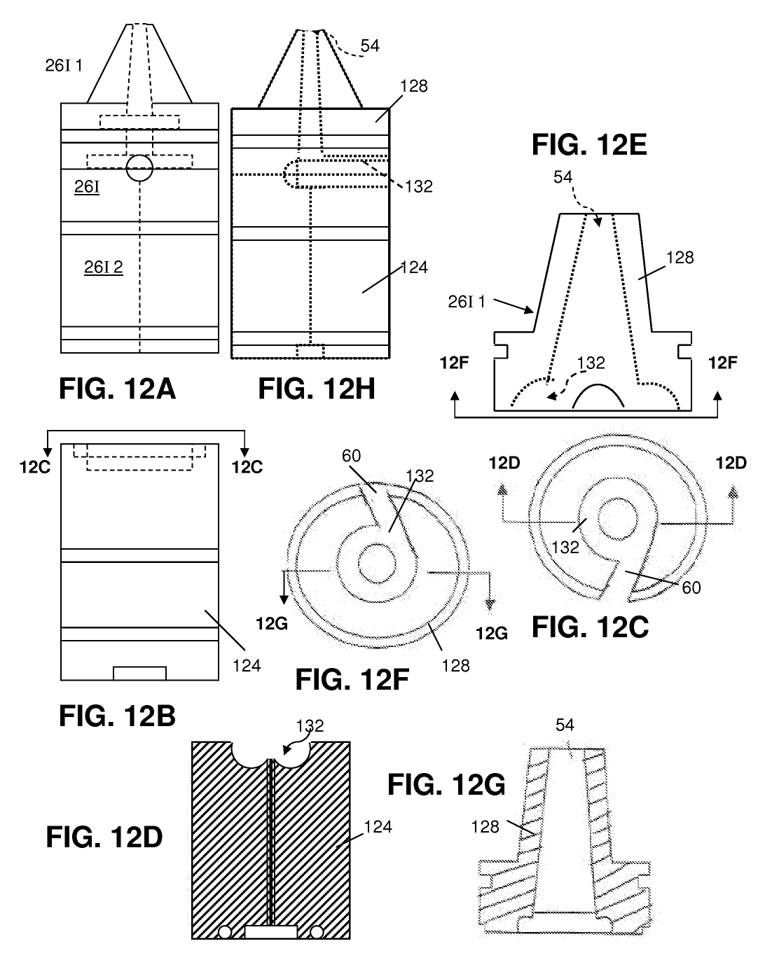

The ultrasonic cavitation chamber is shown in FIG. 13A (end view) and FIG. 13B (side view). The chamber is made from 4″ 316L stainless steel sanitary tubing equipped with Tri-Clover sanitary tube clamps. Ultrasonic cavitation chamber consists of a 4″ six-way stainless steel tubing cross 71 for the mounting of the four Branson ultrasonic transducers assemblies 70 each consisting of a CR Converter 72 part number 101-1350060, Amplitude Booster 74 part number 101-149-098 and Hi-gain Horn 76 part number 316-017-021 and a 4″ water/liquid feedthrough connection for the water/fluid under treatment to pass through the ultrasonic cavitation chamber 78. The flow direction is 90 degrees from the four Branson ultrasonic transducer assemblies 70. Transducer assemblies 70 are mounted between support plates 73 and attached in accordance with Branson mounting instructions provided with the transducer assemblies. Horns 76 are mounted in the four 90 degree cross connections by Tri-Clover sanitary tubing clamps and made water tight by means of O-rings 77 mounted at the nodal point of the horn to limit wear and allow for maximum ultrasonic movement of the transducer horn.

Another embodiment of the present invention consists of a scaled up water treatment system utilizing both ultrasonic cavitation and vortex induced cavitation combined as described in second and third methods to increase efficiency for large scale volume.

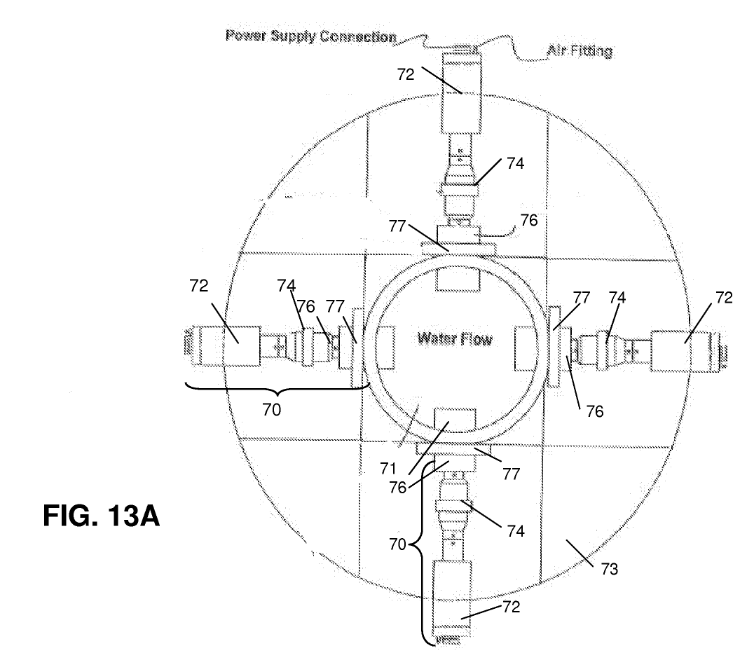

In another embodiment of the cavitation device, a 5-nozzle version, shown in FIG. 16 with nozzles 118A-118E arranged radially around centerline 119, is similar to the version shown in FIG. 11A. This unit could be a replacement part for the embodiment of FIG. 11A to provide increased capacity. It is further envisioned to have any number of nozzles aligned radially around the centerline of the unit.

Or, in other embodiments, the shape may be any useful geometric shape, having any useful number of nozzles, which satisfies the desired goals and conditions.

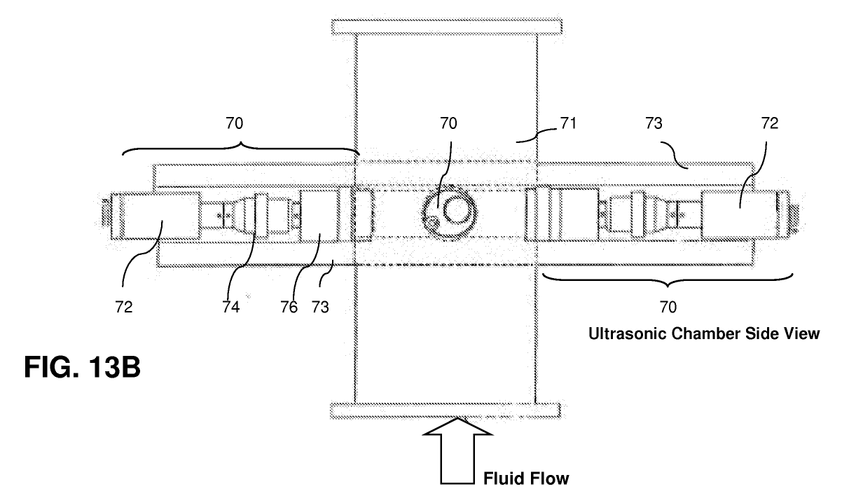

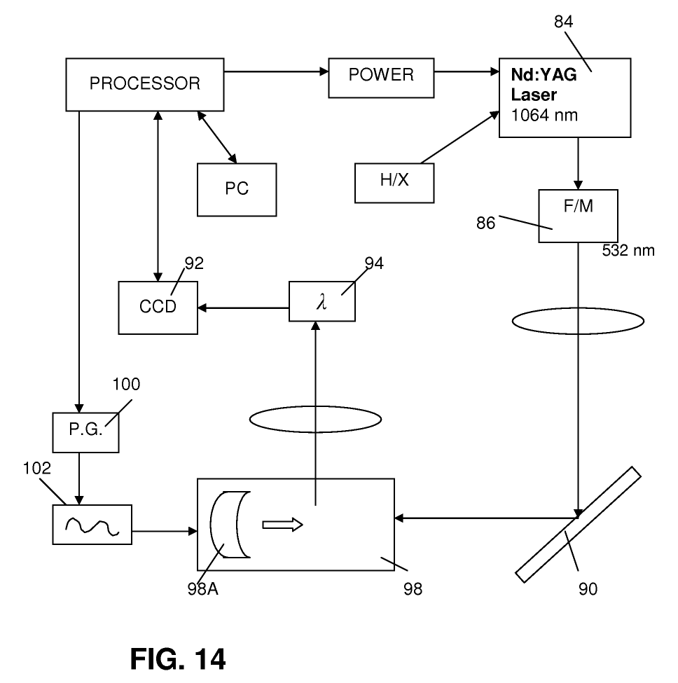

A preferred embodiment of the inventive cavitation device 100 is illustrated in FIG. 17. The device 1100 has a tubular housing 1102 which encloses a pair of nozzles 1104 & 1106. Housing 1102 is preferably formed from 316 stainless steel tubing or a similar corrosion resistant, inert material that is capable of withstanding the elevated operating pressures required for practicing the cavitation process. In the exemplary embodiment, housing 1102 has a diameter on the order of 60 to 80 mm (2.4 to 3.2 in.), although other dimensions may be selection for different applications. End caps 1112 and 1114 are attached to opposite ends of housing 1102 using a pressure-resistant seal. Liquids are introduced through inlet ports 1108 and 1110, where port 1108 supplies nozzle 104 with liquid and port 110 is the supply for nozzle 106. The liquid entering through the two inlet ports is forced into the backside of the corresponding nozzle through a tangential channel and through the nozzle orifice. The nozzles 1104 and 1106 are oriented in an axially aligned, opposing relationship so that the liquid output from each nozzle will directly collide with the output from the other nozzle. This high energy collision results in generation of additional cavitational energy and mixing of the liquid. The nozzles 1104, 1106 emit liquid into common exit volume 1122 and the liquid passes out of the device through discharge port 1132. A view port (shown in FIG. 18) may be provided in housing 1102 adjacent to the exit volume 1122 to permit observation of the fluid during cavitation.

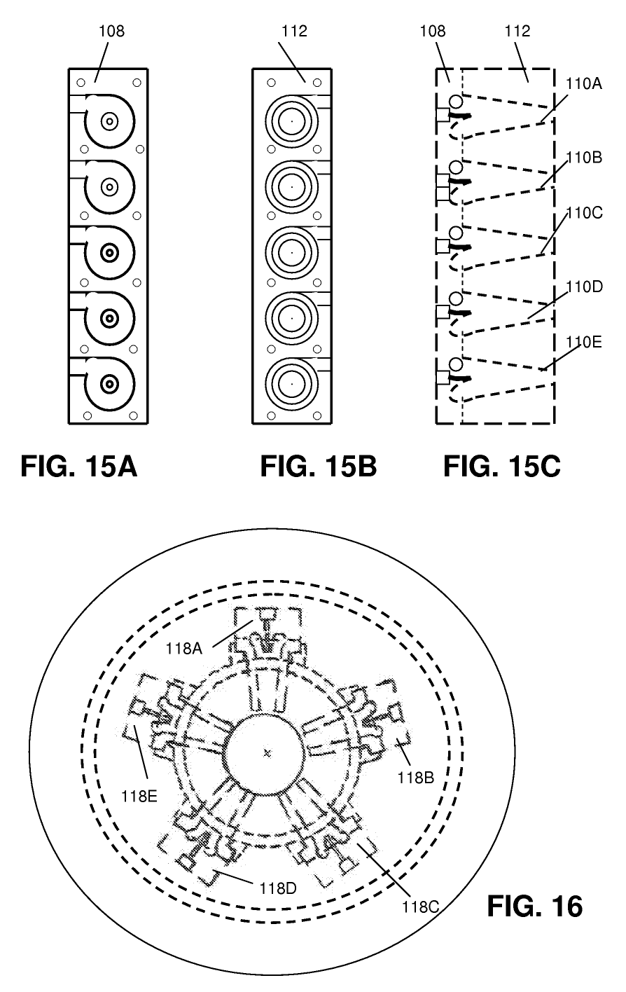

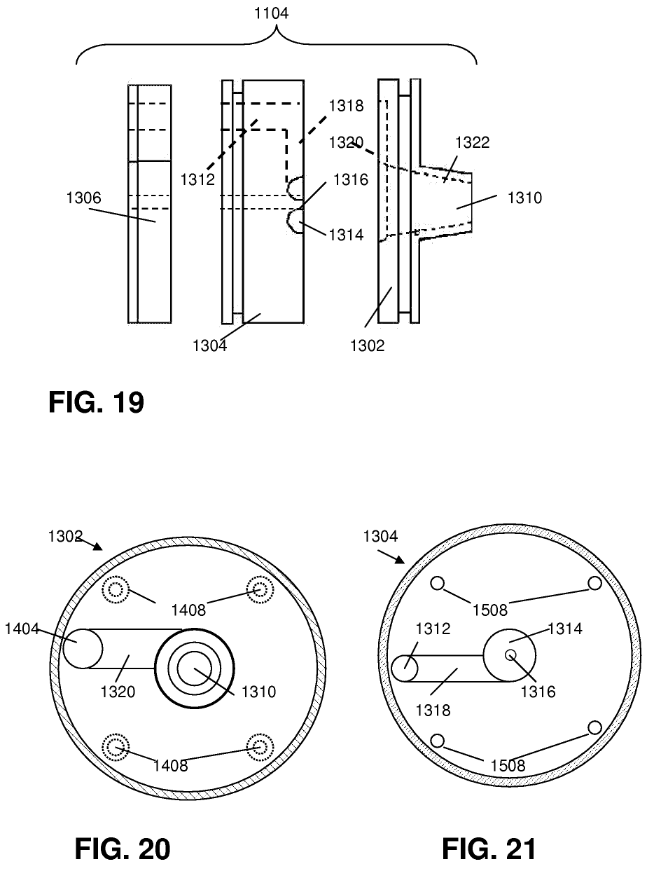

Details of the nozzle construction are illustrated in FIGS. 19-22. Nozzle 1104 is illustrated in FIG. 19. Nozzle 1106 is identical in construction to nozzle 1104 but it oriented within housing 1102 as a mirror image to nozzle 1104. Each nozzle includes three sections, the front section 1302, through which the liquids exit, the back section 1304, which combines with section 1302 to create the rotational vortex needed to induce cavitation, and vacuum plate 1306, which seals the entrance side of the nozzle within the housing interior so that all liquids are forced through the nozzle opening. In the preferred embodiment, the front and back sections are formed from Teflon® (polytetrafluoroethylene) and the vacuum plate 1306 is formed from 316 stainless steel.

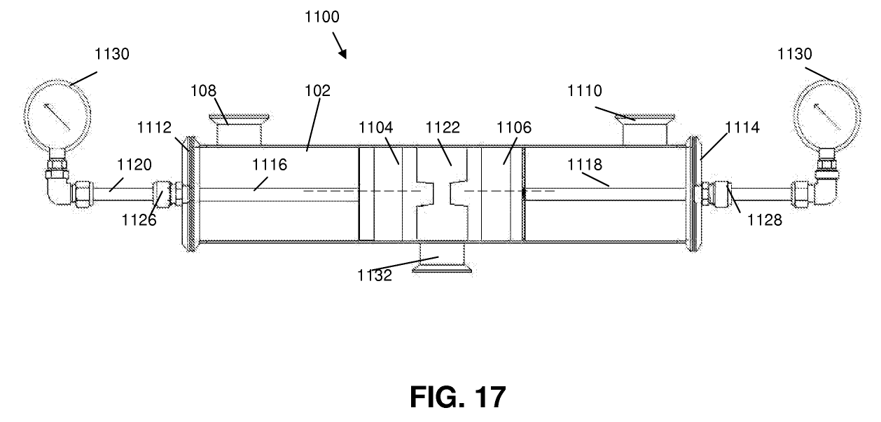

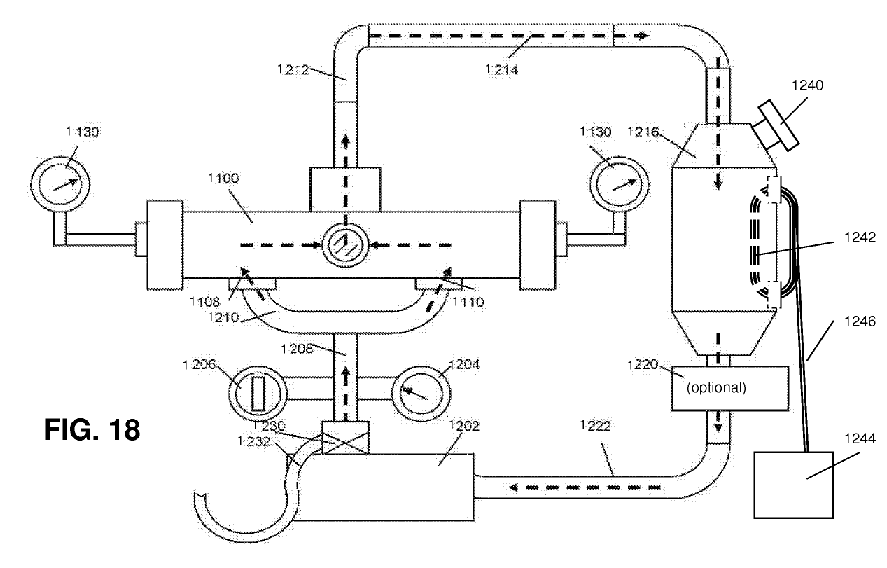

Front section 1302 includes a tapered cone that includes exit orifice 1310. FIG. 20 illustrates the inlet side of front section 1302, which, when assembled with back section 1304, shown in FIG. 21, provides a whirl chamber which is tangentially fed by the feed tube formed by combining recessed channels 1320 and 1318 of the front and back sections respectively. The whirl chamber is formed from the combination of circular channel 1314 and conical surface 1322, with raised center through which vacuum port 1316 extends to define a donut that ensures that the liquid is directed to the sidewalls of conical surface 1322 to generate the desired vortex.

Vacuum plate 1306 has an opening 1602 through which liquids enter the nozzle. Opening 1602 is aligned with input opening 1312 in back section 1304. Bores 1408, 1508 and 1608 are aligned to permit screws (not shown) to be inserted from the exit side of front section 1302 (where bores 1408 are countersunk) to be screwed into bores 1608, which are threaded to receive the screws.

Vacuum plate 1306 preferably has a compressible O-ring seal such as silicone or Viton® around its circumference to provide a tight seal between the edges of plate 1306 and the inner surface of housing 1102 while allowing the position of the nozzle to be moved axially within the housing. An additional aspect of the present invention relates to the ability to alter the distance between the nozzles 1104, 1106 as needed to achieve a desired interaction. The optimal distance may be specific to liquid viscosity and/or may relate to solid components of the liquid, such as in a suspension type system. The optimal distance may be further dictated by optimal treatment temperature per mixture/liquid to be treated. The optimal distance may further be correlated by atmospheric conditions. The provide for such needs, the nozzles of the present device are adjustably connected within the outer housing by means of steel tubes 1116, 1118 that are slidably inserted through the endcaps 1112, 1114 of the housing 1102 and attached to the vacuum plates 1306 at center vacuum orifice 1604 (on the order of 1.6 mm ( 1/16^{th} in.)), allowing the distance between the nozzles 1104, 1106 to be adjusted to a particular need, such as viscosity of the liquid to be processed. Once the desired separation between the nozzles is achieved, their positions are fixed in place by tightening a Swagelock® 1126, 1128 or similar fastener attached to each endcap 1112, 1114. Appropriate fasteners and materials for providing the adjustable nozzle separation are known in the art. Vacuum gauges 1130 connected to each tube 1116, 1118 measure the vacuum produced at the rotational vortex within each nozzle through vacuum orifices 1604 and 1316. The vacuum orifices also provide means for introduction of liquids to be mixed by way of a cannula and an appropriate T-connection (not shown), which is generally known in the art.

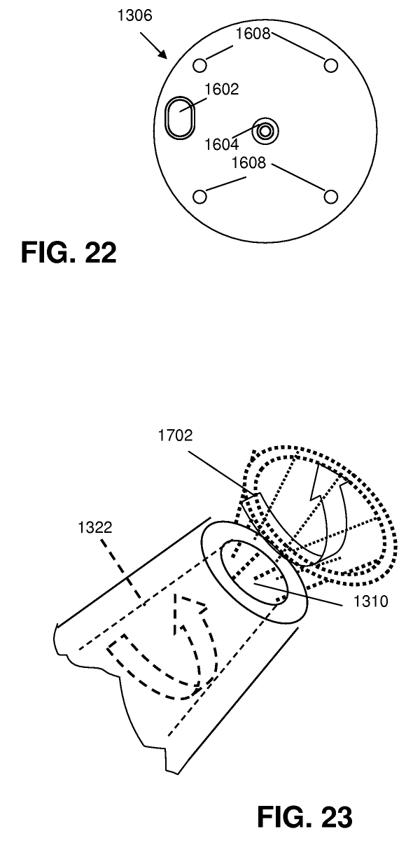

As the liquid is forced through the rotational vortex, centripetal and centrifugal forces cause the water to take on laminar flow and to be forced against the outer portion of the tube through which the liquid is being forced. This combination of forces actually produces laminar flow liquid that is simultaneously rotating. However, this laminar flow liquid is different than the normal understanding of laminar flow fluids. The water flowing from a standard garden hose, is one embodiment of well known laminar flow. However, in the garden hose type of laminar flow the water is of singular molecular motion, in the direction of exiting the hose. Moreover, the water from the garden hose will mimic the interior shape of the hose after exiting the house, until the flow energy is dissipated. However, in the present system, the liquid is forced into a rotational vortex in two dimensions, such that the molecules are rotating in the same rotational manner as the vortex through which the liquid was forced. Secondly, according to the pressure exerted by the liquid being forced around the radius of curvature and the resultant centripetal and centrifugal forces exerted on the molecules of the liquid, the molecules are coerced into a rotational motion simultaneous with being coerced into a laminar flow situation. However, unlike the garden hose example, because the liquid is being forced against the wall of the passage while being coerced into a rotational motion, when the liquid exits the nozzle and is released from the confining tube of the rotational vortex, the liquid forms a thin sheet of liquid. FIG. 23 illustrates the effect that the whirl chamber and conical surface 1322 have on the output stream of liquid 1702. The liquid emitted from exit orifice 1310 has a hollow cone spray pattern that rotates in the same direction with which it was introduced into the whirl chamber. Each nozzle 1104 and 1106 emits the same spray pattern. For further maximizing the effect of the collision of the output streams, the cone spray patterns can rotate in opposite directions. The resulting outputs of the nozzles have rotational momentum and uniform outwardly radiating force, describing a parabola with the vertex at the exit point of the nozzle.

The interior diameter of the feed channel through which the liquid passes, as well as the diameter of the nozzle exit orifice may be altered in size to accommodate need and desired outcome.

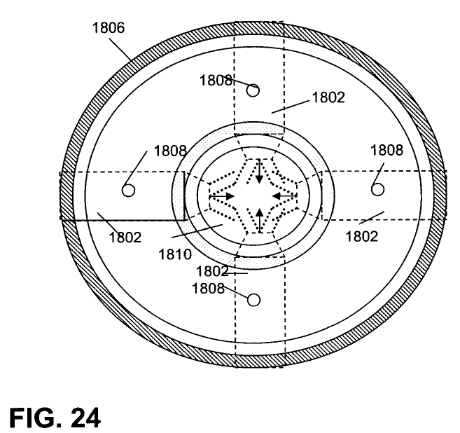

An alternate embodiment of the cavitation device is illustrated in FIG. 24. Four small inverted pump volutes (nozzles) 1802 made of Teflon® without impellers are housed in a 316 stainless steel pipe housing 1806. The volutes 1802 are tangentially fed through openings 1808 by a common liquid source within housing 1806. The common liquid source is fed by the 1V458 Gear pump at 65 psig through an opening 1808 that, although normally used as the discharge of a pump, is utilized as the input for the purpose of establishing a rotational vortex. The liquid entering the four volutes 1802 is directed in a circle 360 degrees and discharged by the means of an 1″ long acceleration tube with a ⅜″ discharge hole. The discharge hole would normally be the suction side of a pump volute but, in this case, is utilized as the discharge side of the device. The four reverse fed volutes 1808 establish rotational vortexes that spin the liquid through one 360 degree rotation, then discharge the liquid down the four acceleration tubes, each of which provides a 6 degree decreasing angle (as measured from the center line of the tube) acceleration section. The accelerated liquid is discharged into a common chamber 1810 at or close to atmospheric pressure. The common chamber is connected to a stainless steel discharge line that feeds back into the top of a tank containing the liquid. At this point, the liquid has made one treatment pass through the device. The process described above is repeated continuously until the energy created by the implosions and explosions of the cavitation (e.g., due to the acoustical energy) have imparted sufficient kinetic heat to the liquid to raise the temperature to a desired level or until a specified processing period has expired. For water, the threshold temperature is about 60° C.

The same or a similar process whereby the liquid or liquids is/are subjected to one or more rotational vortices starting under reduced pressure and experiencing pressure gradients such that cavitation bubbles are formed and implode and explode through the process, will be referred to herein as “physics device”, and/or “physics process”, and/or “vortexing device”, and or “cavitation device”, and/or “cavitating process” and/or “fractionating device”.

An exemplary system for mixing of oil or particles in water is illustrated in FIG. 18. Liquid to be processed is introduced into the process loop through inlet port 1240 in tank 1216 and is pumped into cavitation device 1100 by pump 1202 through a 316 stainless steel line 1208 to a Y-connection 210 which distributes the liquid to the two inlet ports 1108, 1110 or device 1100. Alternatively, liquid or a component to be mixed into the liquid may be introduced through a cannula connected to the vacuum port 1604 of one of the vacuum plates 1306. The liquid is pumped into cavitation device 100 at a pressure such that rotational vortices are produced in each nozzle. The pressure will depend upon the type and viscosity of the liquid to be processed and the nozzle orifice sizes, but the pressure generally falls within the range of 55 to 150 psig. An exemplary pressure for processing water is 65 psig. After subjecting the liquid to the cavitation process, it leaves the device through discharge port 1132 and is directed through stainless steel lines 1212 and 1214 into stainless steel tank 1216. The liquid continues from tank 1216 through stainless steel line 1222 back to pump 1202 for recirculating through the cavitation device for as many iterations until the desired termination point is achieved. Pressure gauge 1204 measures the output pressure from pump 1202 and digital temperature readout 1206 displays the temperature of the liquid as it enters the cavitation device 1100. During processing of water as described in the priority applications, the thermo-physical reactions that occur during the cavitation process cause the water temperature to increase. The temperature is permitted to rise and processing is deemed completed when the water temperature reaches a specified temperature. However, in certain processes, it may be desirable to control the rate of temperature increase in the fluid to maximize mixing time without allowing the fluid to become excessively heated. As illustrated, an optional temperature regulation unit 1220, such as a heat exchanger, cooling jacket, or other cooling means as are known in the art, can be incorporated into the processing loop. While the temperature regulation unit 1220 is illustrated downstream from the tank 1216, it may be placed at other positions within the loop to achieve the same result. In another embodiment, a cooling jacket may be placed around tank 1216.

In a preferred embodiment, temperature regulation is provided by cooling coils 1242 that enter tank 1216 through liquid tight ports in its base or sidewall. The coils should be positioned to avoid interference with the flow of liquid into and out of the tank. The coils are connected to a recirculating cooling bath 1244 by tubing 1246. Water or other coolant such as ethylene glycol is circulated though coils 1242, the outer surfaces of which come into direct contact with the liquid within tank 1216 to draw heat away from the liquid to provide temperature regulation. In the preferred embodiment, the coils 1242 and tubing 1246 are ½ inch copper tubing, which provides a significant advantage since the copper serves as a natural preservative. To enhance the preservative effect, a preferred process includes the addition of a small (catalytic) amount of ascorbic acid into the liquid being processed. The result of the reaction between the ascorbic acid and the copper is a neutral chelate that is naturally anti-fungal, anti-microbial, anti-viral and anti-inflammatory, such that these properties are imparted to the mixture that is being processed. As is known in the art, to provide the desired preservative effect, coils 1242 may be formed from other metals that will form neutral chelates in the presence of an appropriate catalyst that is safe for inclusion in the fluid. Other metals include, but are not limited to silver, gold, zinc, platinum, tungsten, palladium, etc.

Once the desired processing has been completed, as determined either by time or by reaching a specified temperature threshold, valve 1230 is opened to direct the processed liquid out of the loop through tubing 1232 and into an appropriate storage vessel or other container(s) (not shown). While tubing 1232 is illustrated as flexible tubing, it will be readily apparent that rigid tubing, such as the stainless steel line used elsewhere in the loop, may be used to provide a connection between the valve and a reservoir or tank through which liquid may be discharged from the loop.

A mixture of substances to be subjected to the cavitation device is processed in the same manner as water is processed through the device. As occurs during the processing of water, an increase in temperature is observed in the liquid mixture as it is processed. The resultant product is a substance (oil, particulate solid, or a combination thereof) dissolved in water or is water dissolved in oil, which are new compositions of matter.

The inventive device and the use thereof for the dissolving of lipophilics in hydrophilics, and/or the dissolving of hydrophilics in lipophilics, has broad and extensive applications, in the food, medical, cosmetic, environmental, manufacturing and pesticide industries. In any application where it is desired to increase solubility of a lipophilic substance in a hydrophilic liquid, or the inverse, the present inventive device and method are envisioned.

A general method applicable to many applications involves the combination of the substances to be mixed and otherwise dissolved into each other. Pre-mixing is not required. The composition is subjected to the cavitation device in an iterative manner until the desired temperature is achieved. For example, a suitable target temperature for olive oil and water is 140° C. Optimization of the preferred number of iterations may be performed without requiring undue experimentation.

It should be noted that the term “dissolve” is part of a continuum of mixtures. At one end is a pure substance. As one moves along the solvation line, component A is mixed with component B. Where there is true salvation, or miscibility, the atoms of component A are interdispersed with the atoms of component B. If components A and B are miscible, then there are mutually agreeable ionic interactions between all atoms. However, where A and B are not miscible, polar-non-polar interactions ensue and partial or complete separation of the components occurs. In a suspension or dispersion, small micelles are formed of one component that is dispersed or suspended in the other. This arrangement decreases the surface area of repulsive forces. The micelles may be of any size. As the size of the micelles that are suspended or dispersed in the solvent decreases, the system approaches a solvated system. Accordingly, within the context of the present application, a solvated system encompasses microparticulate suspensions and dispersions, whether lipophilic micelles in hydrophilic suspensate, or the inverse. The present application includes combinations of solvation, suspension and dispersion with one or more components, where one component may be miscible in one or more components of the mixture, but which form micelles and are suspended in another component. The types and forms of these mixtures are numerous and increase in complexity based on the number of components in the mixture. The present device and methods of mixing are directed to such complex mixtures.

The term “oil” should be broadly understood to include any lipophilic substance, including where one lipophilic substance is attached or associated with a more traditional oil. For example, a pharmaceutical compound may be bound or associated with an oil such as olive, cotton, linseed or similar, and is included under the terms and the scope of the claims. One or more than one oil shall be included in the term of oil, which is not limited to the singular, but shall include the plural without detracting from, nor limiting the scope of the claims. Moreover, where an oil or lipophilic substance has optical orientation, all enantiomers and diasteriomers and their isomeric derivatives are expressly envisioned.

Other lipophilic substances such as the non-oil perfumes and odorants may be processed in a manner similar to that of oils and shall be understood and included in this invention. Such organic substances are typically soluble in alcohols, yet when subjected to the present device, have increased water solubility.

As used herein, “metastable liquid” shall mean a liquid presenting one or more properties which are different as compared to a normal liquid. A normal liquid in this context shall mean a liquid not having modulated properties, under standard or known conditions, as disclosed in scientific literature and/or known to those of ordinary skill in the relevant art. A “micro-cluster liquid” shall also mean a metastable liquid.

All terms shall include customary and traditional meanings as well as additional interpretations provided by the documents previously incorporated by reference. Any ambiguous or vague term shall first be understood according to the context of the present document, with additional clarification provided according to the disclosures of the documents incorporated by reference.

In addition to the processing of lipophilic substances, the present invention is useful for processing of liquids of varying viscosity. Although not wishing to be bound by any particular theory, it is believed that the physics of the multi-rotational vortex through which the liquid is forced into laminar, rotating, sheet forming flow is an important aspect of the process. One of skill in the art will understand any necessary alterations to physical dimensions to provide such a result.

It has been found that familiar hydrophobic materials can be formed into stable aqueous dispersions by the application of an extraordinary high-pressure, high-shear process that utilizes unique blends of alkylated phosphatidyl choline (soy-derived lecithin). Molecules of phosphatidyl choline and certain other phospholipids will form assemblies with one another in water at extremely low concentrations with a low input of energy. These assemblies are typically bilayers with the polar head group of molecules interacting with aqueous phase. Concurrently, the non-polar, aliphatic portions of several molecules interact with one another or with the non-polar fluid to form a bi-layer.

Phosphatidyl choline can form up to eleven different stereo-chemical assemblies in water depending on the alkyl groups present, the phase transition temperature of the molecule, the concentration of the phosphatidyl choline present, the temperature at the time of formation, and the shearing energy applied during formation. Some of these assemblies are more thermodynamically stable than others depending on the systems energetic state during formation. Typically assemblies formed above the temperature at which the molecule changes the structural character of the phosphatidyl choline (i.e., transition temperature) are more stable because of the lower entropy present. However, assemblies often transition to a less stable assembly as the system is cooled. One type of more stable assembly is known as the lamellar phase (Lα). However, the Lα phase is difficult to form because it requires high energy, even extreme energies.

The solution to this problem is the introduction of high-energy input at low temperatures. This can be achieved by exposing phosphatidyl choline to extremely high shear rates under extreme pressure. One way that such shear can be achieved is by having a fluid physically diverted into two channels that impinge upon each other in a chamber at a substantial velocity, as occurs with the cavitation device. Similarly, extremely high shear rates under extreme pressure and temperature are achieved during the collapse of cavitation bubbles. Under the right combination of shear and pressure, enough energy can be imparted to allow almost instantaneous formation of extremely small droplets of the hydrophobic fluid, which are stabilized by concomitant formation of lamellar phase phosphatidyl choline assemblies. Since the formation process is almost instantaneous, the amount of time that the process media needs to be exposed to high shear rates and extremely high pressures can be very short. This time duration is so short, in fact, that the phosphatidyl choline assemblies formed do not have time to disassemble before they are no longer exposed to the shear and pressure conditions used to form them. Remarkably, by employing this procedure, lipophilic materials can be successfully incorporated into an otherwise all-water-based product.

This second type of assembly that can form is the result of a conversion that occurs in presence of relatively large amounts of hydrophobic material and water. Here, the phosphatidyl cholines rest at the surface of the hydrophobic droplets. The lipophilic tales of phosphatidyl choline extend into the hydrophobic droplets while the more polar heads of the phosphatidyl choline interact with the surrounding water to produce a micelle-like structure. Unlike many emulsions prepared by standard emulsification means, the amount of hydrophobe that can be accommodated into a stable, water miscible dispersion can be greater than 50% by weight. Different hydrophobes vary in their ability to be incorporated into the lamellar phase configuration. Generally, non-polar hydrophobes can be incorporated more easily than can more polar ones. The result of this process is a stable dispersion of highly concentrated hydrophobes that can, thereafter, be freely dispersed in water or water-based products without the risk of separation that occurs in most combinations of this type. Typically, the particle size of the micelle created during this process will be from 100 to 500 nanometers in diameter. This size is about one-tenth to one-fiftieth the size of particles produced by standard emulsification techniques.

The application of the cavitation process of the present invention to oil in water results in the formation of a microemulsion. The inclusion of a phosphatidyl choline, such as a soy-derived lecithin, results in the formation of micelle-like assemblies.

Examples 1-10 below illustrate the application of the cavitation device and method to mixing of various substances with water that has previously been processed using a cavitation device as described above and other steps (cooling and oxygenation) as described in U.S. Pat. No. 6,521,248. Such water is commercially available from Bio-Hydration Research Lab, Inc. (Carlsbad, Calif., USA) under the trademark Penta®

The general procedure for mixing hydrophobic liquids in Penta® water is as follows: the oil or hydrophobic liquid is combined with phosphatidyl choline (soy-derived lecithin) and mixed at room temperature by agitation or stirring until a uniform mixture is achieved. The cavitation device is charged with an appropriate amount of Penta® water at room temperature, 70° F. (21° C.). The oil and lecithin solution is then added to the cavitation device. The mixture is circulated through the cavitation device and system (such as that illustrated in FIGS. 17-18) until the desired particle size, and/or temperature and/or property are achieved.

### Example 1

A mixture of 10% by volume Olive Oil in water is subjected to the cavitation process with test samples taken at 115°, 125°, 135° and 140° C. for determination of the amount of oil dissolved in the water. The maximum amount was 0.04 grams per 10 ml of water.

The oil in water solution has a milky white appearance with a faint Olive Oil odor. The solution was applied to the hands and arms as a lotion and was absorbed very rapidly into the skin and did not leave an oily film or feeling on the skin. The solution was subjected to centrifuge at 12,000 rpm for three 20 minute periods without causing a separation. The solution was further subjected to centrifuge at 20,000 rpm for three 20 minute periods, without separation or change in the solution.

### Example 2

The device used to generate the oil in water according to Example 1 was further fitted on the exterior thereof with a cooling jacket or heat exchange system such that, as heat was generated, it was pulled away from the outside of the device, thereby maintaining the process temperature at a desired point. The system was allowed to process for two hours at 100° F. after which the heat exchanger was removed and the temperature of the liquid was allowed to increase to 140° F. after which the device was turned off and the processed oil in water collected. The average particle size was determined to be 115 nm.

### Example 3

100 g of ZnO and 100 ml of olive oil were added to 20 L of Penta® water in a device similar to those used in the previous Examples. The ZnO had a particle size of 70-80 μm.

The device was also fitted with a temperature control means, such as described previously. The cavitating process was initiated and the internal mixture was allowed to increase in temperature to 100° F. whereupon the temperature control means was initiated and the temperature was held at about 100° F. for two hours. Thereafter, the temperature was allowed to increase to 140° F. whereupon the device was turned off and the mixture collected and analyzed. The ZnO was calculated to have a particle size range of between 0.04 μm and 0.012 μm and the olive oil was determined to have a particle size of 112 nm.

Through the use of the Turbiscan™ device, manufactured by Formulaction (France), it has been determined that particles are produced that are typically smaller than 6 μm, and some are smaller than 180 nm. The observation of particles is important, as it tends to support the conclusion that micelle-like particles are being formed instead of micro-layering. Although the formation of micelle-like assemblies requires high energy, globally high temperatures and pressures are neither employed nor required. The localized energy produced by the collapse of cavitation bubbles is exploited for the needed temperature and pressure. Through the combined use of the cavitation device and Penta® water, oil in water systems comprising up to 50% oil by volume have been produced. The analyzed samples were stable under conditions described. Based on these results, it is believed that micelle-like structures are being formed through the described process.

The incorporation of other hydrophobic substances into the micelle pocket is further contemplated and well supported by these results. The incorporation of vitamins and other hydrophobic materials of biological importance are desirable, especially in view of the metabolic importance of phosphatidyl choline.

Although the examples demonstrate the method whereby the micelles are “filled” or loaded with the hydrophobic material coincident with their formation, i.e. in the cavitation device, it is also envisioned to generate “empty” micelles. Empty micelles are made through the same process as the filled ones, except that the process is run in the absence of a lipophilic component. In this manner, the micelles are formed but are empty, awaiting the introduction of a lipophilic material therein. These empty micelles are filled by high shear mixing with the desired hydrophobe. Such empty micelles may be referred to as “loadable” micelles and/or liposomes. It is not essential that these empty micelles be filled. The loadable micelles also function as non-detergent cleaners, perhaps by pulling the contaminant into the core of the micelle.

For the following examples, particle size analysis was performed using the Turbiscan™ device. Stability of the micelle-like particles was determined with the Turbiscan™ set to the “fixed” scan mode. A fixed scan provides the ability to determine a change in particle size over time. Particle coalescence, particle sedimentation, particle creaming and other stability indicators are obtained through the fixed scan analysis mode.

### Example 4

One liter safflower oil, 50 ml macadamia nut oil, 500 ml borage oil, and 400 ml lecithin were combined. Eight liters of Penta® water were added to the cavitation device and that device was put into operation mode. The hydrophobic mixture was added through standard means to the water in the device. Within one minute the water in the device developed a cloudy appearance, similar to milk. The temperature in the device was held at 110° F. (43.3° C.) for two hours using a temperature regulation unit as previously described.

The mixture was measured using optical backscattering in a container of the liquid. The solution was found to be highly stable, with the percentage of backscattered intensity remaining constant at around 80% for liquid depths from about 8 mm from the bottom of the container up to about 42 mm. Particle diameter at about 13 mm depth was measured as 0.24292 μm and was 1.17776 μm at about 27 mm depth.

### Example 5

Olive Oil 10%: One liter olive oil combined with 473 ml lecithin. Eight liters of Penta® water where added to cavitation device and the device was put in operation mode. The hydrophobic mixture was added through standard means to the water in the device. Within one minute the water in the device became cloudy similar to milk. The temperature in the device was held at 110° F. (43.3° C.) for two hours.

A sample was analyzed for stability. The particle size remained at about 0.202 μm throughout a 30.9 minute test, indicating a highly stable solution.

### Example 6

Olive oil 50%: Five liters olive oil combined with 833 ml lecithin. The device was charged with four liters Penta® water and put in operation mode. The hydrophobic mixture was added through standard means to the water in device. Within one minute the mixture in the device developed a cloudy appearance, similar to milk, and within five minutes the mixture was thick, with a consistency similar toe butter. The device was turned off and samples collected. This material was too thick to ensure proper loading of the sample vial, therefore, no particle or stability analysis performed.

### Example 7

Olive oil mixture: One liter olive oil, 20 grams vitamin E, 15 grams steroyl ester, 40 ml Clarins® tonic oil, 30 ml tea tree oil, 250 ml grape seed oil combined with 400 grams lecithin. Eight liters of Penta® water where added to cavitation device and the device was put in operation mode. The hydrophobic mixture was added through standard means to the water in the device. Within one minute the mixture in the device developed a cloudy appearance, similar to milk. The temperature in the device was held at 110° F. (43.3° C.) for two hours using a temperature regulation unit as previously described.

### Example 8

Jojoba oil: 16 ounces (473 ml) jojoba oil was combined with 96 ml lecithin. The device was charged with eight liters of Penta® water and put in operation mode. The oil and lecithin solution was added through standard means to the water in the device. Within one minute the mixture in the device developed a milky appearance. The device was turned off after thirteen minutes, at which point the temperature was 115° F. (46.1° C.) and samples taken. A stability analysis was performed.

The backscatter decreased very slightly, from about 46.93% to 46.72% over a testing period of 21 minutes. The diameter of the jojoba oil particles varied from 0.13026 μm at about 4.5 minutes to 0.12989 μm at 21 minutes into the test. The lecithin particle diameter was measured as 0.17822 μm at around 12 minutes into the test. Measuring changes in particle diameter with time demonstrated excellent particle size stability at around 0.130 μm.

### Example 9

Tea Tree oil: 16 ounces (473 ml) Tea Tree oil was combined with 96 ml lecithin. The device was charged with eight liters of Penta water and put in operation mode. The oil and lecithin solution was added through standard means to the water in the device. Within one minute the mixture in the device developed a milky appearance. The device was turned off after thirteen minutes and samples taken.

A sample was analyzed for stability. A high level of backscatter remained constant over the testing period, varying less than 0.1%. The sample exhibited excellent particle size stability at around 0.185 μm. The diameters of the tea tree oil particles were very uniform as well as uniformly distributed, varying from 0.18499 μm at about 7 mm depth to 0.18546 μm at about 38 mm. The lecithin (micelle-like) particle diameter was measured as 0.3578 μm at a depth of about 21 mm.

### Example 10

### Lavender Oil

One kilogram lecithin was dissolved in 2 liters Penta® water placed in an empty cavitation device. Another five liters of Penta® water was added and the device was started. The mixture was cycled through the cavitation loop continuously for two hours at 140° F. At this point, 500 ml pure lavender oil is added to the mixture in the device neat. The reaction solution thickened within the subsequent five minutes, becoming too thick for the pump. This sample was collected and found to have the consistency of gelatin.

A sample of the mixture was placed in a beaker at 300° F. for 30 minutes. As the water boiled off, the oil separated out, yet the system did not otherwise separate into distinct layers under the extreme heat. Another sample was placed in a centrifuge for 20 minutes, without causing a separation into phases.

This reaction is believed to be the free-radical catalyzed polymerization reaction of the double bonds found in the lavender oil reactant.

### Example 11

### Process for Converting a Vegetable Oil into Biodiesel

Six liters of pure olive oil were added to the device as described above, 500 ml of anhydrous methanol was also added to the device. The cavitation device was engaged with subsequent rapid increase in temperature to 140° F., over 30 minutes. At this point 60 ml of a ten percent sodium hydroxide in methanol solution was added. Within less than 5 minutes, the reaction temperature dropped rapidly to 122° F. and the color of the reaction liquid changed dramatically from a single phase olive oil color to a three phase system where a portion was light yellow and foamy, a pale ale-colored middle fraction, and a darker, very viscous bottom fraction. The reaction was determined to be complete after less than 5 minutes.

A sample was collected and allowed to stand overnight at around or slightly above room temperature (70-75° F.) to facilitate separation of three phases. The uppermost phase solidified into a soap-like substance, the middle phase remained liquid, having more of the consistency of diesel fuel, and the bottom layer became dark and viscous. A conventional wash may be used at this point to

These results were compared to published biodiesel synthetic procedures and were found to be consistent therewith. The reaction was concluded to be the base catalyzed transesterification of the triglyceride oil (olive oil) to glycerin and the fatty acid methyl ester (FAME), i.e., biodiesel.

### Example 12

### Biodiesel Processing System

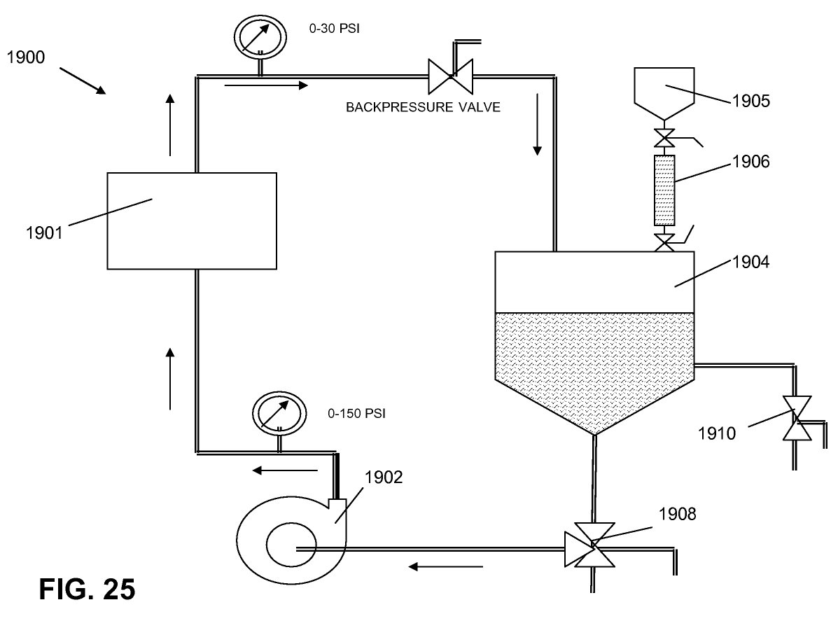

FIG. 25 illustrates the basic components of a biodiesel processing system 1900, which can be scaled to industrial size or sized for home or small business use. The oil may be any vegetable oil, e.g., corn, soy, olive, canola, sunflower seed, or animal fats. Waste cooking oil may also be used, however, it should be processed by centrifugation or other method(s) known in the art to remove foreign particles and contaminants.

Cavitation chamber 1901 is disposed downstream from pump 1902, which, for a system of the type illustrated in FIGS. 17 and 18, pumps 20 gallons per minute at 100 PSI. In the test set-up, a Model FPX 3242-205 centrifugal pump, available from Fristam Pumps USA (Middleton, Wis.) was used, however, selection of an appropriate pump will depend on the system volume, as will be apparent to one of skill in the art. The oil, which is poured into holding tank 1904, is introduced into the processing loop by activating valve 1908 to direct the oil to pump 1902. A sodium methoxide (NaOMe) mixture (sodium hydroxide in methanol) in mixing/holding tank 1905 is injected into tank 1904 by opening the lower valve in injector assembly 1906. Alternatively, injector 1906 can be connected just upstream of the pump to be introduced into the oil once the pump is activated. The ratios of ingredients follow industry standards, with the oil to methanol mixture being on the order of 5:1 up to 10:1 or more. In the illustrated system, all of the methanol and sodium hydroxide are pre-mixed in mixing/holding tank 1905. In an alternate embodiment, the bulk of the methanol may be poured directly into the oil in tank 1904, with only a small amount of methanol being used to dissolve the sodium hydroxide to form an injectable liquid.

The oil mixture is circulated through the loop until the mixture temperature reaches about 60° C. (˜140° F.). Again, it should be noted that no external heat source is required to attain the target temperature—the increase in temperature is the result of cavitation alone. The rapid increase in temperature from the cavitation causes the sodium methoxide mixture to catalyze the reaction more rapidly than conventional methods, thus permitting the use of 30 to 40% less of the caustic catalyst. The cavitation also provides a significant advantage in that processing of the batch of biodiesel is completed in less than 5 minutes. Yield is on the order of 99% or better due to the efficient usage of the components that is made possible by the cavitation.

After processing through the cavitation loop, the resulting mixture must be allowed to settle to separate the biodiesel from the glycerol. Typically, settling takes several hours to several days, as is known to those of skill in the art. For a smaller volume system for home or small business use, settling can be done in tank 1904, with the glycerol being drained through valve 1908 once the separation is complete. The biodiesel is drawn through drain port 1910. In a larger volume industrial system, the mixture will be transferred to a separate settling tank to permit continued operation of the cavitation loop. Alternatively, a commercially-available biodiesel centrifuge may be used to separate the FAME and glycerol in minutes rather than waiting several hours for settling to occur. Such centrifuges are available from Dolphin Marine and Industrial Centrifuges (Farmington Hills, Mich.) and US Centrifuge of Indianapolis, Ind., among others.

After separation, the biodiesel should be washed to remove contaminants using conventional washing methods. In the test process, bubble washing was used. Alternatively, a waterless wash can be performed using an ion exchange resin, such as EZ-Clean® dry wash resin available from A1 Biofuels Ltd. of British Columbia, Canada, among others. The latter method has the advantage of producing no toxic waste stream.

The inventive device and method provide means for mixing oils with other materials to produce stable mixtures rapidly and with greater efficiency than conventional methods. With regard to mixing oils with water, where prior efforts have failed, the present method provides stable oil in water solutions. For production of biofuels, the device and method allow processing in a fraction of the time required by conventional processes using smaller amounts of catalyst and less energy.

While the above examples describe preferred embodiments of the present invention and describes many potential uses for the products of the present invention, the reader should understand that many other embodiments of the present invention are possible and should be obvious to persons skilled in this art. For example there are many techniques for creating cavitation in water and other fluids in addition to the ones described above. Accordingly, the scope of the present invention is determined solely from the claims and their legal equivalents.

1. A method for producing a mixture of an oil and a non-oil liquid comprising:
iteratively cycling the oil and the non-oil liquid together within a loop comprising a cavitation device to produce cavitation bubbles within the oil and the non-oil liquid, wherein collapse of the cavitation bubbles produces shock waves that produce localized heat and pressure to mix the oil and non-oil liquid; and
terminating the cycle once a desired reaction has occurred.

2. The method of claim 1, wherein the non-oil liquid is an alcohol and the desired reaction is transesterification.

3. The method of claim 2, wherein the oil is a vegetable oil or animal fat.

4. The method of claim 2, wherein the mixture comprises biodiesel and a glycerol by-product.

5. The method of claim 1, wherein the non-oil liquid is water and the mixture comprises a stable suspension comprising micelles.

6. The method of claim 1, wherein the desired reaction occurs when the mixture is heated to a predetermined temperature.

7. The method of claim 6, wherein the predetermined temperature is 60° C.

8. A method for producing a biofuel, comprising:
providing a loop comprising a cavitation device and a pump;
introducing a mixture of an oil, an alcohol and a catalyst into the loop;
iteratively cycling the mixture through the cavitation device to produce cavitation bubbles within the mixture, wherein collapse of the cavitation bubbles produces shock waves that produce localized heat and pressure to induce a reaction to convert the mixture into the biofuel and a glycerol by-product; and
separating the biofuel from the glycerol by-product.

9. The method of claim 8, comprising combining the alcohol and the catalyst prior to mixture with the oil.

10. The method of claim 8, wherein the oil comprises vegetable oil or animal fat.

11. The method of claim 8, wherein the alcohol is methanol.

12. The method of claim 8, wherein the cycling is terminated once the mixture reaches a pre-determined temperature.

13. The method of claim 12, wherein the pre-determined temperature is 60° C.

14. The method of claim 8, further comprising after separating the biofuel, washing the biofuel to remove contaminants.

15. A device for producing a mixture of an oil and non-oil liquid, comprising:
a processing loop;
means of introducing the oil and non-oil liquid into the processing loop;
a pump for pumping a combination of oil and non-oil liquid iteratively through the processing loop until a predetermined condition is achieved;
a cavitation device disposed within the loop, the cavitation device comprising a plurality of nozzles disposed within a chamber, wherein the plurality of nozzles produce cavitation bubbles within the oil and non-oil liquid, wherein collapse of the cavitation bubbles produces shock waves that produce localized heat and pressure to induce reaction between the oil and non-oil liquid; and
an outlet port for removing a reacted mixture once the predetermined condition has been achieved.

16. The device of claim 15, wherein the oil is vegetable oil and the non-oil liquid is methanol.

17. The device of claim 15, further comprising a temperature sensor, wherein the predetermined condition is heating the mixture to a predetermined temperature.
